(19) United States
(12) Patent Application Publication
(10) Pub. No.: US 2018/0313426 A1
(43) Pub. Date: Nov. 1, 2018

(54) Torsional Vibration Damping Arrangement For The Powertrain Of A Vehicle

(71) Applicant: ZF FRIEDRICHSHAFEN AG, Friedrichshafen (DE)

(72) Inventors: Tobias DIECKHOFF, Wuerzburg (DE); Matthias FISCHER, Oerlenbach (DE); Reinhard FELDHAUS, Euerbach (DE)

(21) Appl. No.: 15/773,302

(22) PCT Filed: Oct. 5, 2016
(86) PCT No.: PCT/EP2016/073717

§ 371 Date: May 3, 2018

(30) Foreign Application Priority Data
Nov. 6, 2015 (DE) 10 2015 221 894.5

(51) Int. Cl. F16F 15/131; F16F 15/14

(52) U.S. Cl. CPC F16F 15/13157; F16F 15/1478

(57) ABSTRACT

A torsional vibration damping arrangement for the powertrain of a vehicle comprises an input region) to be driven for rotation around a rotational axis (A) and an output region), there being provided between the input region) and the output region) a first torque transmission path) and, parallel thereto, a second torque transmission path) and a coupling arrangement). A phase shifter arrangement) is provided in the first torque transmission path), and a torsional vibration modification arrangement) is arranged in the first torque transmission path) between the phase shifter arrangement) and the coupling arrangement) and/or a torsional vibration modification arrangement) is arranged in the second torque transmission path) upstream of the coupling arrangement).

### PRIORITY CLAIM

This is a U.S. national stage of application No. PCT/EP2016/073717, filed on Oct. 5, 2016. Priority is claimed on the following application: Country: Germany, Application No.: 10 2015 221 894.5, Filed: Nov. 6, 2015; the content of which is/are incorporated in its entirety herein by reference.

### BACKGROUND OF THE INVENTION

The present invention is directed to a torsional vibration damping arrangement for the powertrain of a vehicle, comprising an input region to be driven for rotation around a rotational axis and comprising an output region, there being provided between the input region and the output region a first torque transmission path and, parallel thereto, a second torque transmission path and a coupling arrangement for superimposing the torques conducted via the torque transmission paths, wherein a phase shifter arrangement is provided in the first torque transmission path for generating a phase shift of rotational irregularities conducted via the first torque transmission path in relation to rotational irregularities conducted via the second torque transmission path.

German Patent Application DE 10 2011 007 118 A1, the entire content of which is hereby incorporated by reference, discloses a torsional vibration damping arrangement which divides the torque introduced into an input region, for example, through a crankshaft of an internal combustion engine, into a torque component transmitted via a first torque transmission path and into a torque component conducted via a second torque transmission path. When the torque is divided in this way, not only is a static torque divided, but the vibrations or rotational irregularities which are contained in the torque to be transmitted and which are generated, for example, through the periodically occurring ignitions in an internal combustion engine are also distributed proportionally to the two torque transmission paths. The coupling arrangement in this case brings the two torque transmission paths together again and guides the combined total torque into the output region, for example, a friction clutch or the like.

A phase shifter arrangement is provided in at least one of the torque transmission paths and is constructed in the manner of a vibration damper, i.e., with a primary element and a secondary element which is rotatable relative to the primary element owing to the compressibility of a spring arrangement. A phase shift of up to 180° occurs in particular when this vibration system passes into a supercritical state, i.e., is excited by vibrations which lie above the resonant frequency of the vibration system. This means that with a maximum phase shift the vibration components delivered by the vibration system are shifted in phase by 180° with respect to the vibration components received by the vibration system. Since the vibration components guided via the other torque transmission path do not undergo a phase shift or, if so, a different phase shift, the vibration components which are contained in the combined torque components and which are then shifted in phase relative to one another can be destructively superposed one upon the other so that, ideally, the total torque guided into the output region is a substantially static torque which does not contain any vibration components.

### SUMMARY OF THE INVENTION

It is an object of the present invention to provide a torsional vibration damping arrangement which has an improved vibration damping behavior in a simple construction. According to the invention, this object is met by a torsional vibration damping arrangement for a powertrain of a vehicle, comprising an input region to be driven for rotation around a rotational axis (A) and an output region, wherein there are provided parallel to one another between the input region and the output region a first torque transmission path for transmitting a first torque component of a total torque to be transmitted between the input region and the output region and a second torque transmission path for transmitting a second torque component of a total torque to be transmitted between the input region and the output region, a phase shifter arrangement at least in the first torque transmission path for generating a phase shift of rotational irregularities conducted via the first torque transmission path in relation to rotational irregularities conducted via the second torque transmission path, wherein the phase shifter arrangement comprises a vibration system with a primary element and a secondary element which is rotatable relative to the primary element around the rotational axis (A) against the restoring action of a damper element arrangement, and a coupling arrangement for combining the first torque component transmitted via the first torque transmission path and the second torque component transmitted via the second torque transmission path and for routing the combined torque to the output region, wherein the coupling arrangement comprises a first input element connected to the first torque transmission path, a second input element connected to the second torque transmission path, and an output element connected to the output region, wherein a torsional vibration modification arrangement is arranged in the first torque transmission path between the phase shifter arrangement and the coupling arrangement and/or a torsional vibration modification arrangement is arranged in the second torque transmission path upstream of the coupling arrangement.

As a result of the torsional vibration modification arrangement in the first torque transmission path and/or in the second torque transmission path, the effect of a torsional vibration decoupling with two torque transmission paths, also known as torsional vibration damping arrangement with power splitting, can be improved in operating states in which the torsional vibrations, also known as alternating torques, at the first input element and second input element of the coupling arrangement have a mismatched amplitude ratio and/or a mismatched 180-degree phase shift relative to one another. This means, for one, that the amplitudes of the torsional vibrations in the two torque transmission paths are changed upstream of the coupling arrangement through the torsional vibration modification arrangement such that these torsional vibrations are advantageously reduced, ideally even completely extinguished, after superposition in the coupling arrangement. To this end, a torsional vibration energy can be introduced into one or both torque transmission paths through the torsional vibration modification arrangement in order to obtain a required amplitude. The same situation holds for the additional phase shift through the torsional vibration modification arrangement. If there is not yet an optimal phase shift of 180° of the two torsional vibrations in the two torque transmission paths relative to one another upstream of the coupling arrangement, the phase shift can be advantageously influenced through the torsional vibration modification arrangement. To this end, the torsional vibration modification arrangement acts as an additional phase shifter arrangement. In both cases, i.e., in case of amplitude change or phase shifting, the torsional vibration modification arrangement works as an active influencing device. This means that the existing parameters of amplitude and phase shift in the two torque transmission paths are determined by a sensor arrangement. After correlating with reference parameters, the amplitude and/or the phase shift are influenced to form an optimal value through an active engagement of control electronics through the torsional vibration modification arrangement in order to obtain a torque with preferably no torsional vibrations after the two torque transmission paths are brought together.

In a further advantageous embodiment, the torsional vibration modification arrangement comprises an energy storage. As has already been mentioned, the energy storage is chiefly advantageous for removing the surplus energy in the vibrations and storing it in the energy storage. If energy is to be introduced into the vibration again, the energy required for this can be taken from the energy storage. The energy storage can be configured, for example, as an electrical, mechanical, pneumatic or hydraulic energy storage. Since the charging of the energy storage and the removal of energy from the energy storage do not take place without losses, it may be advantageous when the energy storage is additionally supplied with energy from an external energy source, for example, an alternator which is driven by the internal combustion engine.

A further advantageous embodiment provides that the torsional vibration modification arrangement is configured as an amplitude modification arrangement and/or as a phase shifter modification arrangement. This is particularly advantageous when the vibrations to be superposed in the two torque transmission paths have a different amplitude and/or an unfavorable phase shift for the superposition of the two torsional vibrations in the coupling arrangement prior to a combination of the two torque transmission paths in the coupling arrangement. In order to obtain the most advantageous destructive superposition of the two torsional vibrations in the coupling arrangement, it is necessary to have the amplitudes of the torsional vibrations in the two torque transmission paths in a defined ratio relative to one another and, in order to obtain the most advantageous destructive superposition of the two torsional vibrations in the coupling arrangement, it is further necessary that the phase shift of the torsional vibrations in the two torque transmission paths be 180° with respect to one another. To this end, energy can be added to the torsional vibrations or energy can be removed, for example, into the energy storage.

In a further advantageous embodiment, it is provided that the torsional vibration modification arrangement comprises at least one sensor, a control device and an actuator. In order to control an active vibration modification, it is necessary to identify the ratio of amplitudes of the torsional vibrations, also known as alternating torques, and the phase position thereof relative to one another in the two torque paths of the torsional vibration damping arrangement with power splitting. To this end, it is advantageous when a direct measurement is carried out with corresponding sensors. The acquired data are conveyed to a control device and processed in the control device using reference data and/or using further data, for example, accelerator position, speed, crankshaft angle and additional data that are advantageous for calculating an output signal. The output signal is sent to an actuator which executes the required steps for an advantageous reduction of vibrations. Depending on the conditions which have been determined by the control device, the following steps can advantageously be taken.

For the case where the alternating torques in the two torque transmission paths of the power split accord with one another sufficiently advantageously with respect to phase and—corresponding to a gear ratio of the coupling arrangement—sufficiently advantageously with respect to amplitude, no active vibration modification is necessary.

For the case where the alternating torque at the input element of the coupling arrangement at which the active vibration modification can be carried out is too large for an ideal complete extinction in the coupling arrangement, the energy in the half-waves of the oscillation of the alternating torque in which there is an energy surplus can be removed via an electric machine in generator operation and stored temporarily in an energy storage. In the half-waves of the oscillation with an energy deficiency, mechanical energy which was removed from the energy storage as electrical energy is introduced via the electric machine into the rotor, i.e., the respective branch of the power split.

For the case where the alternating torque at the input element of the coupling arrangement at which the active vibration influencing is to be applied is too small for an ideal complete extinction in the coupling arrangement, energy can be introduced in the half-waves of the oscillation of the alternating torque in order to achieve the necessary vibration amplitude in both directions.

A great advantage of the active vibration influencing combined with power splitting is that the vibrations can be variously influenced via the active element, the actuator. This is particularly advantageous because different orders of vibration excitation at different speeds can be optimally decoupled by a passive decoupling system with power splitting. Through the active influencing, the amplitudes and phases of different orders can be adapted in such a way that they can be decoupled equally well for an existing gear ratio of the coupling arrangement.

In a further advantageous configuration, it is provided that the actuator is operated hydraulically and/or pneumatically. The actuator can actively change or influence the vibration in the respective torque transmission path. To this end, the actuator is configured in such a way that it can carry out a change in amplitude and/or a phase shift of the vibrations in the respective torque transmission path. To this end, a hydraulic and/or pneumatic energy can be converted in the actuator into a mechanical energy which can actively change the vibration with respect to amplitude and/or phase.

In a further advantageous configuration, it is provided that the actuator is operated electromechanically and/or electromagnetically. The actuator can actively change or influence the vibration in the respective torque transmission path. To this end, the actuator is configured in such a way that it can carry out a change in amplitude and/or a phase shift of the vibrations in the respective torque transmission path. To this end, an electromechanical and/or electromagnetic energy is converted in the actuator into a mechanical energy which can actively change or influence the vibration with respect to amplitude and/or phase.

Further, it can be advantageous when the energy storage is filled with energy from a torsional vibration in the first torque transmission path and/or in the second torque transmission path via the actuator. For this purpose, the actuator is used as a generator which converts the energy in the torsional vibrations into an energy which is storable in the energy storage. In order to introduce as little additional external energy as possible into the system, it is advantageous to store the surplus energy in the torsional vibrations in the energy storage.

In a further advantageous embodiment, the coupling arrangement is configured as a planetary gear set. Different embodiments can be used. In this regard, it can be advantageous when the first input element of the planetary gear set is configured as a ring gear, the second input element of the planetary gear set is configured as a sun gear, and the output element is configured as a ring gear. However, other connection variants are also possible and are already known from the prior art.

A further advantageous embodiment provides that the coupling arrangement is formed as a lever coupling gear unit. Here again, connection variants for connecting the first input element, second input element and output element to one another by means of a lever element are known from the prior art.

In a further advantageous embodiment, the coupling arrangement is constructed as a magnetic coupling gear unit. The functioning of the magnetic coupling gear unit, which may also be referred to as a magnetic gear unit, is comparable to that of a known planetary gear set. The magnetic coupling gear unit includes an external rotor which has on its inner side permanent magnets which alternately have a magnetic north polarity and magnetic south polarity. An internal rotor which likewise has permanent magnets with alternating polarity is arranged radially inside of the external rotor.

A modulator ring alternately having a ferromagnetic segment and a nonmagnetic segment is located radially between the two rotors or magnet arrangements.

In a practical implementation, it is advantageous primarily for reasons of strength that the ferromagnetic elements of the modulator ring are embedded in a closed supporting construction. The fastening of the permanent magnets to the rotors is also known and need not be discussed further.

Magnetic fields are generated in each instance by the magnet arrangements at the external rotor and internal rotor. The quantity of magnets in the two arrangements is to be coordinated in such a way that the magnetic fields do not mutually influence one another without the modulator ring. However, as a result of the quantity and arrangement of the ferromagnetic segments of the modulator ring, the magnetic fields are modulated such that a magnetic coupling occurs between the internal rotor and the external rotor.

The mathematical-physical relationships for determining the required quantity of magnet pairs at the internal rotor and external rotor and ferromagnetic elements of the modulator ring are known in the art and need not be discussed further. However, it should be noted that a large range of gear ratios is possible between the three gear unit elements as a result of an appropriate configuration, that this is determined only by the ratios of the quantity of magnet pairs and modulator segments and that, for each quantity of pole pairs of the two rotors, two different numbers of modulator segments are possible by which a different rotational direction of the modulator ring is achieved with respect to one of the other rotors.

With respect to its basic functioning, the operation of a gear unit of this type is similar to that of a planetary gear set. Accordingly, it is also possible to use it as a coupling arrangement for torsional vibration mitigation with two torque transmission paths.

When using the magnetic gear unit as coupling arrangement, also known as magnetic coupling gear unit, it can be particularly advantageous because the gear unit can be operated free of lubricant, the gear unit elements do not touch one another and, consequently, operate without wear and without noise except for the bearing noise, and the magnetic gear unit is safeguarded against overload because it merely slips without sustaining damage when a maximum torque is exceeded.

Further, with a magnetic gear unit, gear ratios between the individual rotors can be adjusted very flexibly. In this respect, the gear ratio is independent of the radii of the gear unit elements. Also, the rotational direction of the modulator ring can be freely adjusted with respect to the rotors which also allows a greater number of connection variants in the powertrain with two torque transmission paths.

Further, it can be advantageous that the coupling arrangement in configured as an electromagnetic coupling gear unit. The magnetic fields which are generated through permanent magnets in the magnetic gear unit as has just been described can also be generated by electric coils.

In a further advantageous configuration, the torsional vibration modification arrangement is integrated in the coupling arrangement. In this case, the component parts of the coupling arrangement can be used at least partially for the torsional vibration modification arrangement, which is advantageous for installation space and because fewer component parts are needed.

For example, an external rotor of an electromagnetic coupling gear unit can also be used as actuator for changing torsional vibrations. This can also apply, for example, to the internal rotor of an electromagnetic coupling gear unit.

### BRIEF DESCRIPTION OF THE DRAWINGS

The present invention will be described in more detail in the following with reference to the accompanying figures in which:

FIG. 1 is a schematic view of a torsional vibration damping arrangement in which the torque transmission path is divided into two torque transmission paths and with a torsional vibration modification arrangement;

FIG. 2 is a vibration characteristic on primary side and secondary side;

FIG. 3 is a vibration characteristic with an amplitude change;

FIG. 4 is a vibration characteristic with an amplitude change and a phase shift;

FIG. 5 is a torsional vibration damping arrangement with two torque transmission paths as linear model;

FIG. 6 is a torsional vibration damping arrangement with two torque transmission paths as linear model and with hydraulic/pneumatic torsional vibration modification arrangement in the first torque transmission path;

FIG. 7 is a torsional vibration damping arrangement with two torque transmission paths as linear model and with an electromechanical torsional vibration modification arrangement in the first torque transmission path;

FIG. 8 is a torsional vibration damping arrangement with two torque transmission paths as linear model and with a linear electric-motor torsional vibration modification arrangement in the first torque transmission path;

FIG. 9 is a torsional vibration damping arrangement with two torque transmission paths as linear model and with a linear electric-motor torsional vibration modification arrangement in the second transmission path;

FIG. 10 is a torsional vibration damping arrangement with two torque transmission paths as linear model and with a linear electric-motor torsional vibration modification arrangement in the first torque transmission path and in the second torque transmission path;

FIG. 11 is a torsional vibration modification arrangement integrated in an electromagnetic coupling gear unit;

FIG. 12 is a cross section of FIG. 11;

FIG. 13 is a torsional vibration modification arrangement integrated in an electromagnetic coupling gear unit;

FIG. 14 is a cross section of FIG. 13;

FIG. 15 are two torsional vibration modification arrangements integrated in an electromagnetic coupling gear unit;

FIG. 16 is a cross section of FIG. 15;

FIGS. 17-19 are a schematic view of a torsional vibration damping arrangement with a magnetic coupling gear unit and with a torsional vibration modification arrangement;

FIG. 20 is a schematic view of a torsional vibration damping arrangement with a planetary coupling gear unit and with a torsional vibration modification arrangement;

FIG. 21 is a schematic view of a torsional vibration damping arrangement with a lever coupling gear unit and with a torsional vibration modification arrangement;

FIG. 22 is a schematic view of a torsional vibration damping arrangement with a magnetic coupling gear unit and with a torsional vibration modification arrangement and with an active control unit; and

FIG. 23 is a schematic view of a torsional vibration damping arrangement with a magnetic coupling gear unit and with a torsional vibration modification arrangement and with an active control unit.

### DETAILED DESCRIPTION OF THE PRESENTLY PREFERRED EMBODIMENTS

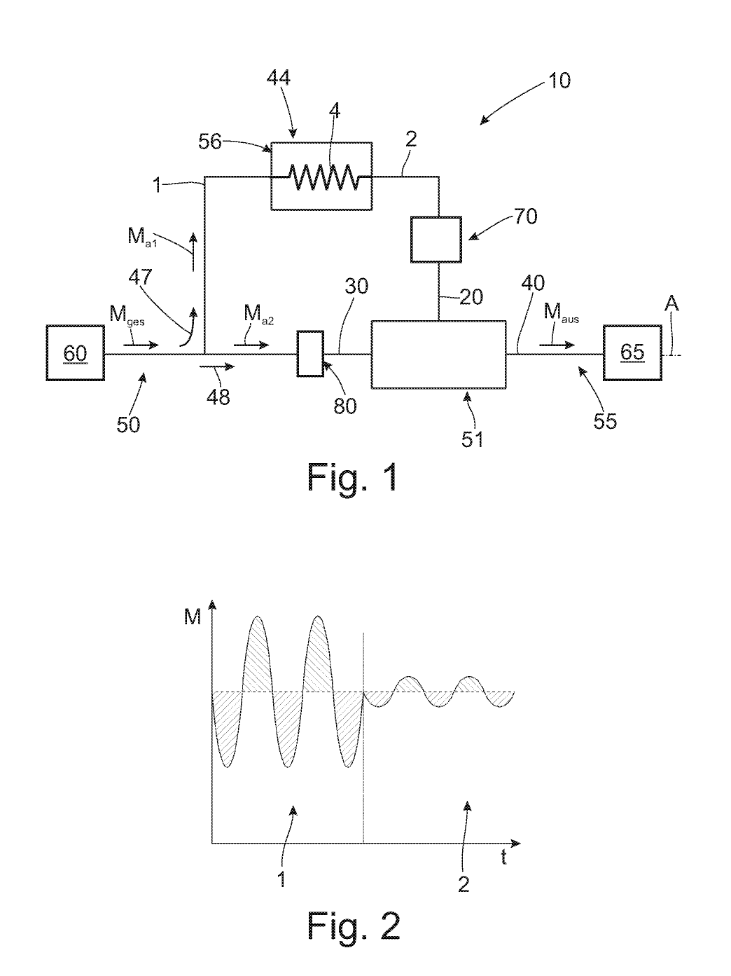

A first embodiment of a torsional vibration damping arrangement, designated in its entirety by 10, which operates according to the principle of power splitting or torque splitting will be described in the following referring to FIG. 1. The torsional vibration damping arrangement 10 can be arranged in a powertrain, e.g., in a vehicle, between a drive unit and the following portion of the powertrain, for example, a transmission, a friction clutch, a hydrodynamic torque converter or the like.

The torsional vibration damping arrangement 10 shown schematically in FIG. 1 comprises an input region, designated in its entirety by 50. This input region 50 can be connected, e.g., screwed, to a crankshaft, not shown, of a drive unit 60. In the input region 50, the torque received from the drive unit 60 branches into a first torque transmission path 47 and a second torque transmission path 48. In the region of a coupling arrangement, designated in its entirety by 51, the torque components Mₐ₁ and Mₐ₂ conducted via the two torque transmission paths 47, 48 are combined again to form an output torque Mₐᵤₛ and then routed to an output region 55 which can preferably be formed by a transmission 65.

A vibration system, designated in its entirety by 56, is integrated in the first torque transmission path 47. The vibration system 56 acts as a phase shifter arrangement 44 and comprises a primary element 1 to be connected to the drive unit, for example, and a secondary element 2 which further guides the torque. The primary element 1 is rotatable against a damper element arrangement 4 relative to the secondary element 2.

It will be appreciated from the foregoing description that the vibration system 56 is constructed in the manner of a torsional vibration damper with one or more spring sets 4 as is shown here. Through a selection of the masses of the primary element 1 and of the secondary element 2 and choice of the stiffness of the spring set or spring sets 4, it is possible to set a resonant frequency of the vibration system 56 in a required ranged in order to achieve a favorable phase shift of torsional vibrations in the first torque transmission path 47 relative to the second torque transmission path 48. The coupling arrangement 51 of the torsional vibration damping arrangement 10 guides the two torque components Mₐ₁ and Mₐ₂ together again. This is effected in that the two torque components Mₐ₁ and Mₐ₂ and, therefore, also the torsional vibration components are superposed in such a way that, in an optimal case with a 180-degree phase shift of the two torsional vibration components and with identical amplitude of the two torsional vibration components in the two torque transmission paths 47, 48, a torque Mₐᵤₛ without torsional vibration components is guided to the output region 55 after superposition in the coupling arrangement 51. In case the amplitudes and/or the phase shift are not advantageously present upstream of the coupling arrangement 51, the amplitude and/or the phase shift of the torsional vibrations in the two torque transmission paths 47; 48 can advantageously be actively changed by a torsional vibration modification arrangement 70; 80 in order to obtain an optimal superposition in the coupling arrangement. This is particularly advantageous in coupling arrangements 51 having a fixed gear ratio. Accordingly, by means of the torsional vibration modification arrangements 70; 80, the torsional vibrations in the two torque transmission paths can be changed with respect to amplitude and phase shift such that the torsional vibrations are advantageously destructively superposed on one another, optimally completely extinguished, at the given gear ratio in the coupling arrangement 51.

FIG. 2 clearly shows where it is advantageous to carry out an active influencing of torsional vibrations. The torsional vibration components in the area of the primary element 1, i.e., upstream of the phase shifter arrangement 44, i.e., on the primary side, are greater than in the area of the secondary element 2, i.e., downstream of the phase shifter arrangement 44, i.e., on the secondary side. It is shown in an idealized manner in FIG. 2 how the torque oscillates in a sine-shaped manner around a mean value on the primary side and on the secondary side. Accordingly, in this case, the active vibration reduction means that the deviations from the mean value in both directions are compensated by a corresponding counter-torque.

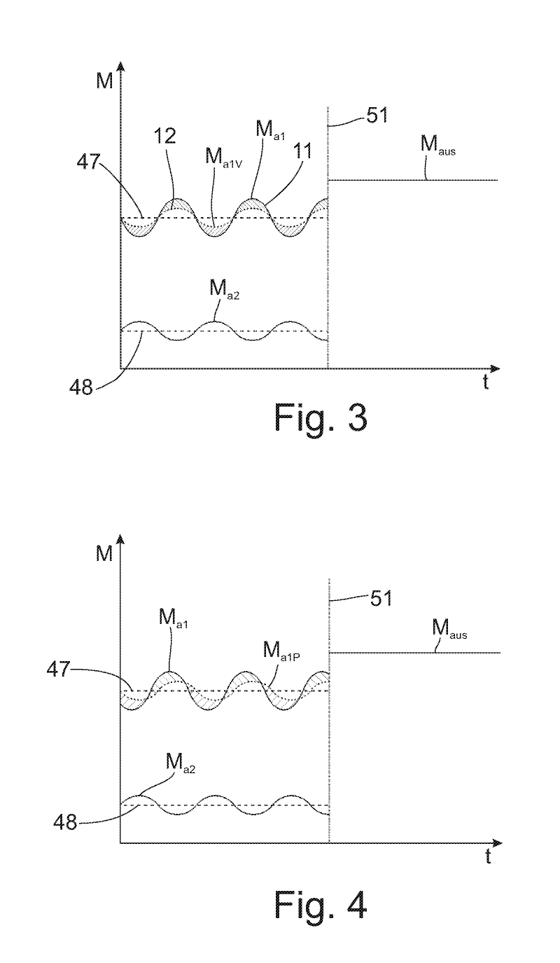

FIG. 3 shows an energy quantity which is needed to effect a change in amplitude, for example, in the first torque transmission path 47. It corresponds to the area between an actual curve 11 and a reference curve 12. While the areas above and below the mean value are identical in theory so that, given a lossless storage and transformation of the energy surplus of a half period, the energy deficit of the following half period can be compensated without additional expenditure of energy, it is useful in practice to keep the energy quantity to be transferred between system and storage as small as possible in view of the existing efficiency of less than 1.

Therefore, compared to a purely active vibration reduction on the primary side, an active vibration reduction on the secondary side of a dual mass flywheel already has the advantage that the vibrations to be eliminated are passively pre-filtered and, therefore, appreciably less power is needed so that there are also fewer losses and the vibration damping arrangement can be dimensioned smaller. If the amplitude is adjusted through a removal of energy and addition of energy in the torsional vibration 11 in the first torque transmission path 47 such that a modified first torque component M_{a1V} is present, the latter can be combined in the coupling arrangement 51 so as to be shifted in phase with respect to torsional vibration Mₐ₂ in the second torque transmission path 48 to form a torque Mₐᵤₛ without torsional vibrations.

FIG. 4 schematically shows when a phase shift is carried out additionally by a torsional vibration modification arrangement in the first torque component Mₐ₁ in the first torque transmission path 47. Through an optimal phase shift of 180°, an output torque Mₐᵤₛ without torsional vibrations can be generated by a superposition of the two torque components M_{a1P} and Mₐ₂ in the coupling arrangement 51.

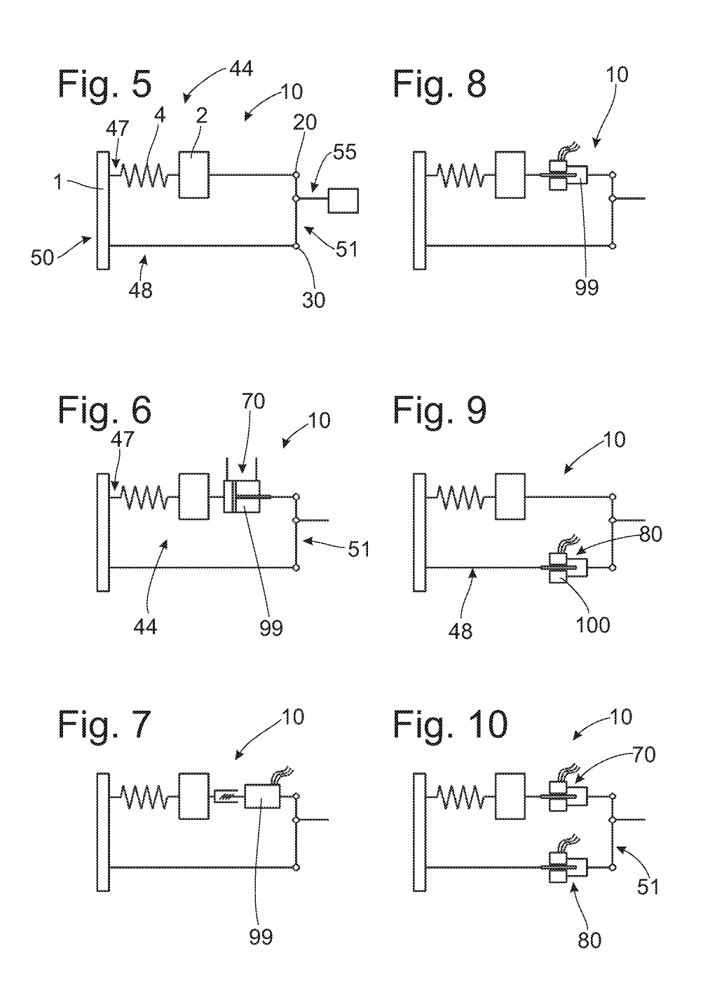

FIGS. 5 to 10 show translational models of a torsional vibration damping arrangement 10 with power splitting or torque splitting. FIGS. 6 to 10 show various implementations of an active vibration modification.

FIG. 5 shows a basic model of the torsional vibration damping arrangement 10 with power splitting as a linear model without active vibration modification. A primary element 1 which is subject to vibration is connected to a damper element arrangement 4 and to a secondary element 2 in a first torque transmission path 47, together forming a phase shifter arrangement 44. The output of the phase shifter arrangement 44 forms a first input element 20 of a coupling arrangement 51. A second torque transmission path 48 connects the primary element 1 directly to a second input element 30 of the coupling arrangement 51. The vibrations which are phase-shifted relative to one another in the two torque transmission paths 47; 48 are guided together again through the coupling arrangement 51 and accordingly are ideally destructively superposed such that, ideally, there are no longer any vibrations present at an output region 55.

FIG. 6 shows a torsional vibration damping arrangement 10 such as that shown in FIG. 5 but with an active torsional vibration modification arrangement 70 in the first torque transmission path 47. In this case, the active torsional vibration modification arrangement 70 is arranged between the phase shifter arrangement 44 and the coupling arrangement 51. The torsional vibration modification arrangement 70 is constructed with an actuator 99 which can be operated hydraulically or pneumatically.

FIG. 7 shows a torsional vibration damping arrangement 10 such as that shown in FIG. 6 but with an actuator 99 of the torsional vibration modification arrangement 70, which actuator 99 can be operated electromechanically, for example, with an electric motor and a transmission element.

FIG. 8 shows a torsional vibration damping arrangement 10 such as that shown in FIGS. 6 to 7 but with an actuator 99 of the torsional vibration modification arrangement 70, which actuator 99 is formed as electromagnetic linear motor.

FIG. 9 shows a torsional vibration damping arrangement 10 in which a torsional vibration modification arrangement 80, in this case also constructed with an electromagnetic linear motor as actuator 100, is arranged in the second torque transmission path 48. The above-mentioned constructional variants of the actuator 99 which were described in the first torque transmission path can also be applied in the second torque transmission path 48.

FIG. 10 shows a torsional vibration damping arrangement 10 in which a torsional vibration modification arrangement 70; 80 is arranged in both torque transmission paths 47; 48. Here also, the embodiments mentioned above referring to FIGS. 6 to 9 can be combined to obtain an advantageous amplitude change and/or an advantageous phase shift of the torsional vibrations in the two torque transmission paths so that the latter are advantageously destructively superposed in the coupling arrangement 51.

The following figures show an implementation of the linear model of a torsional vibration damping arrangement 10 with an active torsional vibration modification arrangement 70; 80, such as that described referring to FIGS. 6 to 10, in a rotational system.

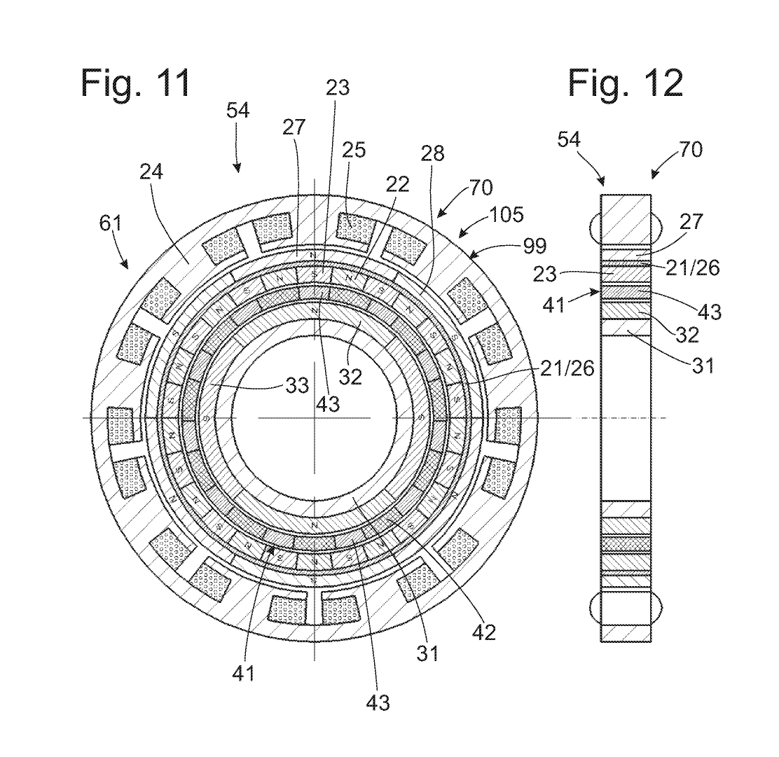

FIGS. 11 and 12 show an electromagnetic coupling gear unit 62 in which a torsional vibration modification arrangement 70, in this case an electric actuator 99 in the form of an electric motor 105, is integrated. This is particularly advantageous because, in this case, the components of the electromagnetic coupling gear unit 62 can also be used simultaneously as a torsional vibration modification arrangement 70. In doing so, the electromagnetic coupling gear unit 62 can be used in a manner comparable to a known planetary gear set. To this end, for example, the external rotor 21 is connected via the first input element 20 to the first torque transmission path 47 as can be seen in FIG. 1, the internal rotor 31 is connected via the second input element 30 to the second torque transmission path 48 as can be seen in FIG. 1, and the modulator ring 41 is connected via the output element 40 to the output region 55 as can be seen in FIG. 1. The external rotor 21 is outfitted radially inwardly with permanent magnets 22; 23. Located farther radially inward is an internal rotor 31 which is also formed with permanent magnets 32; 33 at its radially outer region. A modulator ring 41 having ferromagnetic segments and nonmagnetic segments 42; 43 alternately in circumferential direction is arranged between the external rotor 21 and the internal rotor 31.

The construction is intended as an example, particularly as concerns the dimensions and the quantity of the different magnet pairs and the segments in the modulator ring 41. In a practical implementation, the ferromagnetic elements 42 of the modulator ring 41 would also preferably be embedded in a closed supporting construction for reasons of strength instead of the various segments merely being joined to one another in circumferential direction as is shown here. However, this is known from the art. The same also applies to the fastening of the permanent magnets 22, 23, 32; 33 to the rotors.

Magnetic fields are generated by the magnet arrangements 22; 23 and 32; 33, respectively. The quantity of magnets in the two arrangements is coordinated in such a way that the magnetic fields do not mutually influence one another without the modulator ring 41. As a result of the quantity and arrangement of the ferromagnetic segments 42 of the modulator ring 41, however, the magnetic fields are modulated in such a way that a magnetic coupling takes place between the internal rotor 31 and the external rotor 21. The mathematical-physical relationships for determining the required quantity of magnet pairs at the internal rotor 31 and external rotor 21 and of the ferromagnetic elements 42 of the modulator ring 41 have long been known in the art and need not be discussed further. However, it should be noted that a large range of gear ratios is possible between the three gear unit elements 21, 31; 41 as a result of an appropriate configuration, that this is determined only by the ratios of the quantity of magnet pairs and modulator segments and that, for each quantity of pole pairs of the two rotors 21;31, two different numbers of modulator segments 42; 43 are possible by which a different rotational direction of the modulator ring 41 is achieved with respect to one of the other rotors 21; 31.

The basic functioning of the magnetic coupling gear unit 61 is similar to that of a known planetary gear set which is previously known from the prior art for torsional vibration damping arrangements with two torque transmission paths. Accordingly, it is also possible to use it as a coupling arrangement 51 for the torsional vibration damping arrangement 10 with two torque transmission paths.

There are various advantages in using the magnetic coupling gear unit 61. For one, the magnetic coupling gear unit 61 can be operated free of lubricant, since the gear unit elements 21; 31; 41 do not touch each other. Additionally, the magnetic coupling gear unit 61 operates free from wear and virtually free from noise except for the noise brought about by a bearing support of the gear unit elements 21; 31; 41. The magnetic coupling gear unit 61 is also safeguarded against overload because it merely slips comparable to a stepper motor without sustaining damage when a maximum torque is exceeded. A larger number of connection variants of the torsional vibration damping arrangement 10 with two torque transmission paths is also made possible owing to the fact that the gear ratios can be adjusted very flexibly and independently from the radii of the gear unit elements 21; 31; 41 in magnetic gear units, as in the magnetic coupling gear unit 61 shown herein, and owing to the rotational direction of the modulator ring 41 being adjustable independently from the gear ratio.

Further, the electric motor 105 shown herein corresponds to a permanently excited synchronous machine. In principle, however, other constructions such as a brushless DC motor, stepper motors or other known constructions are also possible, for example.

The electric motor 105 is formed of a stator 24 which has a determined quantity of stator windings 25 which generate electrical fields. A rotor 26 of the electric motor 105 is formed in this case through an arrangement of permanent magnets 27; 28 which are arranged radially outwardly on the external rotor 21. Owing to the electric motor 105, it is now possible to rotate the external rotor 21 relative to the stator 24. While this does not alter the gear ratio of the transmission, per se, the rotation of the external rotor 21 relative to the stator 24 is superposed on the rotational movements of the transmission elements 21; 31; 41. In this way, torsional vibrations can also be introduced into the external rotor 21 or—when the electric motor 105 operates in generator mode—vibration components with an energy surplus can be converted into electrical current.

The depiction is only meant symbolically, particularly as concerns the dimensions and quantity of the various magnet pairs 22; 23; 32; 33, modulator segments 42; 43 and stator windings 25. A configuration of these components is carried out in accordance with the prior art which is not described in more detail herein.

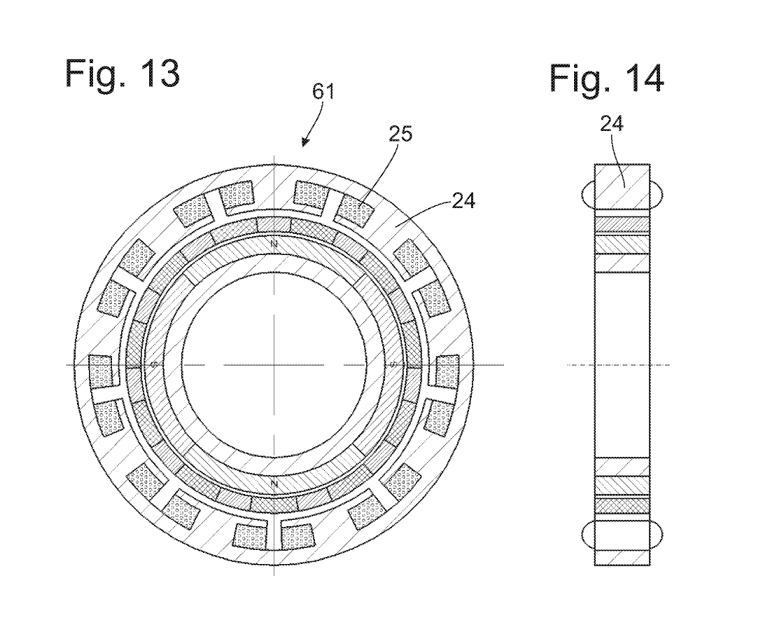

FIGS. 13 and 14 show a simplified construction compared to the construction described with reference to FIGS. 11 and 12. The external rotor 21 with its permanent magnets 22; 23 as shown in FIGS. 11 and 12 is omitted in FIGS. 13 and 14. The required magnetic field is replaced with an electromagnetic field of the stator winding 25 of stator 24. If a constant current is applied to the stator winding 25, the function is equivalent to that described referring to FIGS. 11 and 12.

However, by appropriate wiring of the stator windings, it is also possible to generate a rotating electromagnetic field which mimics the function of a rotating external rotor 21 such as is described in FIGS. 11 and 12. Advantages of this arrangement are a small component part requirement in contrast to the embodiment in FIGS. 11 and 12 and a lower mass moment of inertia of the coupling arrangement 61 overall, which allows greater dynamics. Here also, the depiction of the component parts is meant to be exemplary.

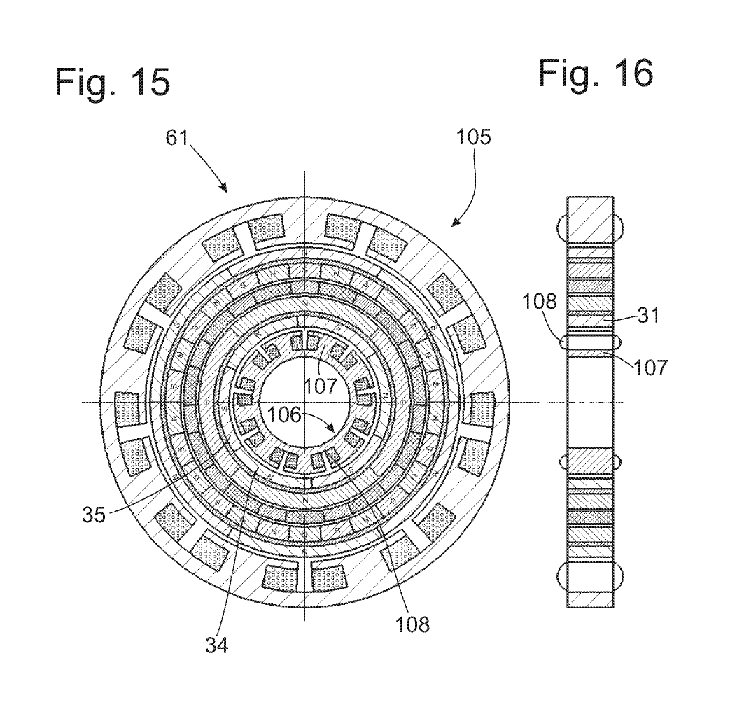

FIGS. 15 and 16 show a magnetic coupling gear unit 61 such as that already described referring to FIGS. 11 and 12 but with an additional electric machine 106 which acts on the internal rotor 31. The electric machine is also integrated coaxially and in the same axial installation space as electric machine 105 which acts on the external rotor. This is particularly economical with respect to installation space. The construction of the electric machine 106 for the internal rotor 31 is comparable to that of electric machine 105 for the external rotor. A further stator 107 with stator windings 108 is located radially inside of the internal rotor 31. The second electric machine 106 is formed together with the internal rotor 31 which additionally carries an arrangement of permanent magnets 34; 35 on its inner side. Accordingly, a modification of torsional vibrations in the form of added energy or removed energy can also take place in the second torque transmission path 48.

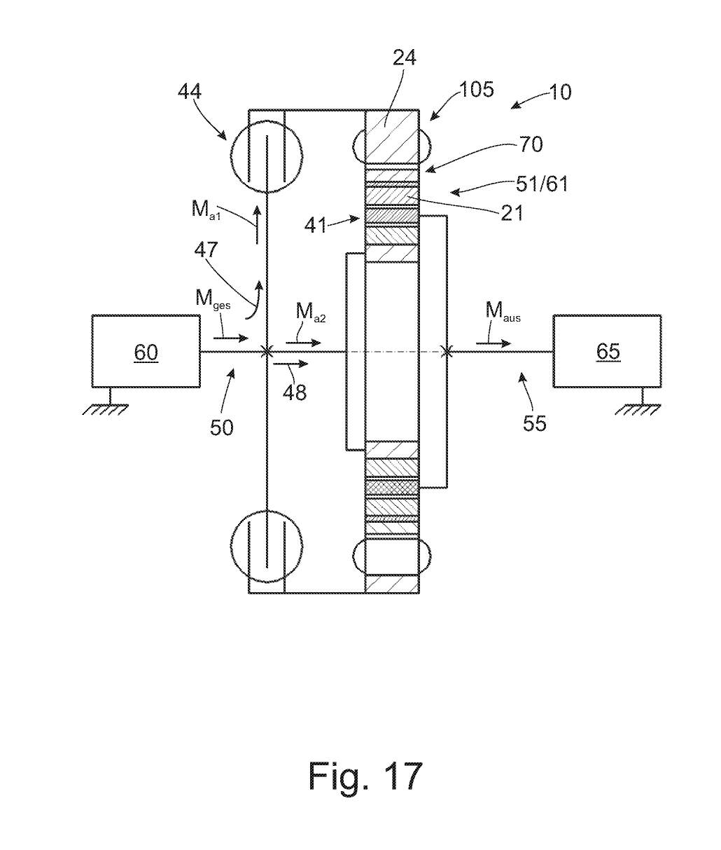

FIG. 17 shows a connection variant of a torsional vibration damping arrangement 10 with an active vibration modification arrangement 70 at the external rotor 21, which active vibration modification arrangement 70 is integrated in a magnetic coupling gear unit 61.

Generally speaking, energy is added to or removed from the powertrain or, more precisely, to or from the torque to be transmitted, by the active vibration modification. The addition or removal of energy can be carried out, for example, in the form of electrical energy which is then in turn converted into mechanical work. Different arrangements of an active vibration modification can be distinguished in principle by whether the system which implements the energy conversion is arranged within the power flow of the drive or the forces involved in the conversion are supported relative to a reference system, in this case the vehicle.

FIG. 17 shows a schematic construction of a motor vehicle powertrain with a torsional vibration damping arrangement 10 with power splitting. As has already been mentioned in the description of FIGS. 11 and 12, the coupling arrangement 51 of the torsional vibration damping arrangement 10 is constructed as a magnetic coupling gear unit 61 and has an integrated electric motor 105 which acts on the external rotor 21. The stator 24 is connected to the output of the phase shifter arrangement 44 so that the magnetic coupling gear unit 61 is located with the electric motor 105 directly in the first torque transmission path 47. This connection arrangement is particularly advantageous because the mass of the stator 24 has a favorable effect on a supercritical operation of the phase shifter and, consequently, on an advantageous phase shift of—ideally—180° of vibration components in the first torque transmission path 47 in relation to the torsional vibrations in the second torque transmission path 48.

If a total torque M_{ges} coming, for example, as in this case, from a drive unit 60 is conducted to a transmission 65, the torque transmission path branches into two torque transmission paths 47; 48 at input region 50. The phase shifter arrangement 44 which causes the phase shift of the torsional vibration components in the first torque transmission path 47 relative to the torsional vibration components in the second torque transmission path 48 is arranged in the first torque transmission path 47. The two torque transmission paths 47; 48 and, therefore, also the two torsional vibration components contained in torque components Mₐ₁; Mₐ₂, are combined again at the magnetic coupling gear unit 61 to form an output torque Mₐᵤₛ. The external rotor 21 is connected to the first torque transmission path 47, the second torque transmission path 48 is connected to the internal rotor 31, and the output region 55 is connected to the modulator ring 41. In order to achieve an ideal superposition of vibrations, the two torsional vibration components must have an identical amplitude and a phase shift of 180°. If this is not the case, a change in amplitude and/or a change in the phase shift can be carried out via the torsional vibration modification arrangement, in this case through an electric motor 105, in the first torque transmission path 47 such that an optimal superposition of the two torques Mₐ₁ and Mₐ₂ with the torsional vibrations contained therein is carried out and a torque Mₐᵤₛ without torsional vibrations is present at the output region 55. The electric motor 105 can change the amplitude and/or the phase shift of the torsional vibration components in the first torque transmission path 47 through a short-term supply of rotational energy and/or through a short-term uptake of rotational energy.

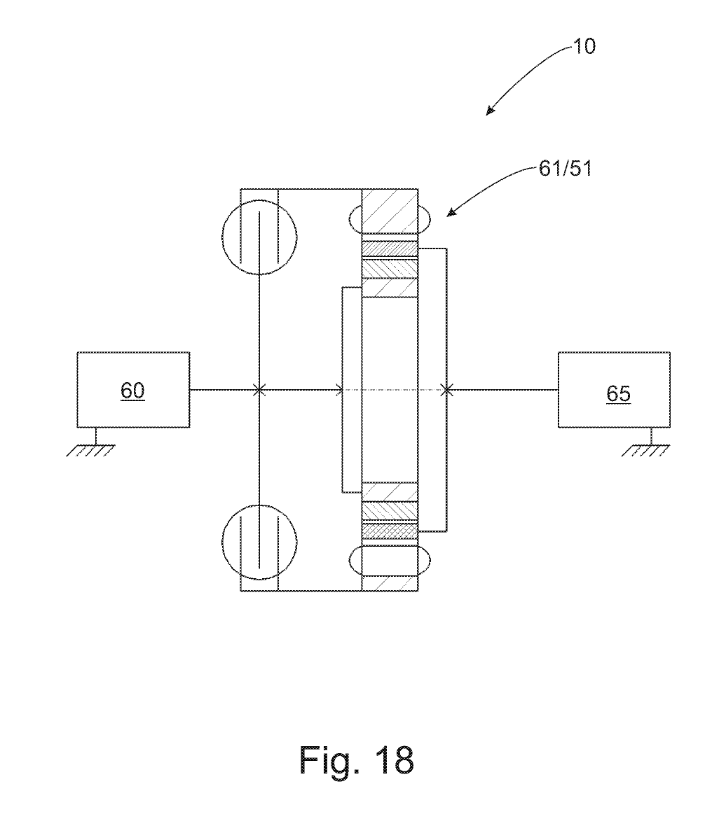

FIG. 18 likewise shows a torsional vibration damping arrangement 10 with power splitting and a magnetic coupling gear unit 61 as coupling arrangement 51 as has already been described in FIG. 17. In this case, however, the simplified embodiment of the magnetic coupling gear unit 61 from FIGS. 13 and 14 is used. The advantages in this case are a greater dynamic of the overall torsional vibration damping arrangement 10 based on a lower mass inertia than for the construction in FIG. 17. Further, this embodiment is advantageous because there are fewer parts owing to the omission of the external rotor.

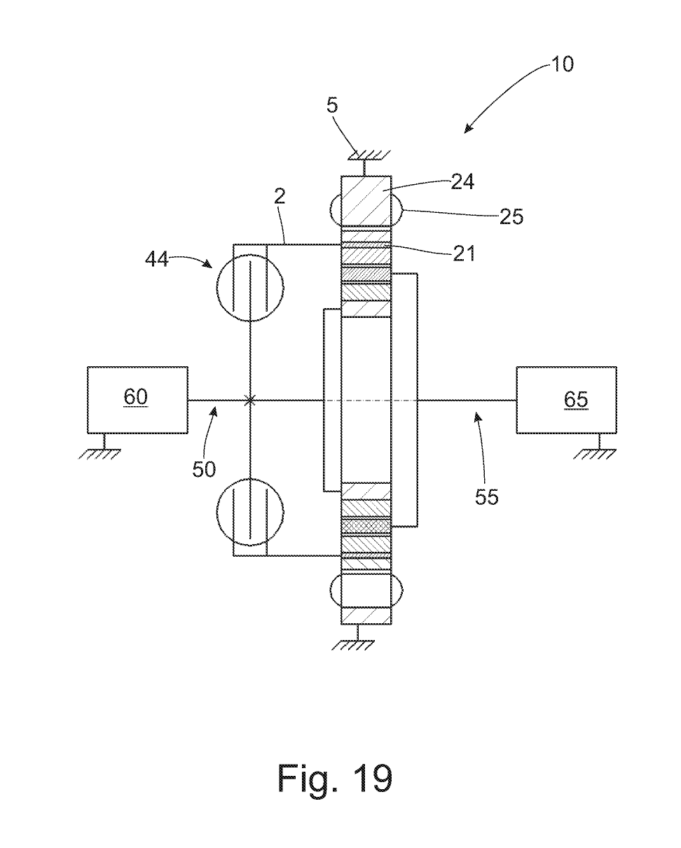

FIG. 19 shows a torsional vibration damping arrangement 10 which is based on the basic principle from FIG. 17. However, the stator in FIG. 19 is fixedly connected to the environment, i.e., the vehicle 5. The external rotor 21 is connected to the first torque transmission path 47, more precisely to the secondary element 2, in this instance the output of the phase shifter arrangement 44. This arrangement is particularly advantageous because the torque transmission path from the input region 50 to the output region 55 is also possible in a de-energized state of the stator winding 25. A further advantage consists in that the current-conducting component parts, in this case the stator 24 with its stator winding 25, are stationary with respect to the vehicle, and a power supply, for example, through slip rings, is therefore dispensed with.

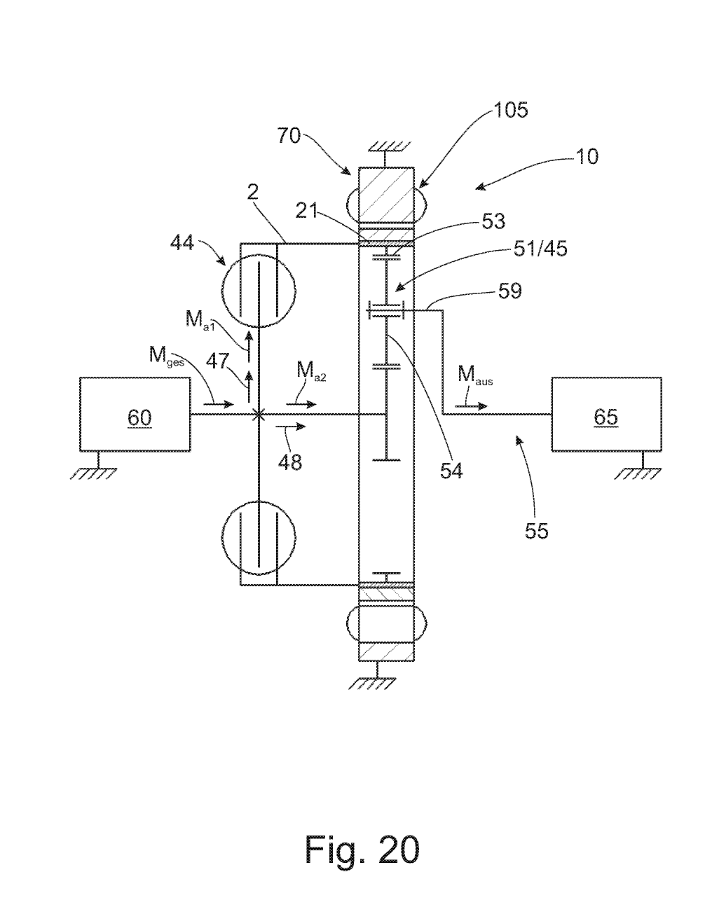

FIG. 20 shows a torsional vibration damping arrangement 10 with a torsional vibration modification arrangement 70 and a planetary gear set 45 as a coupling arrangement 51.

An active vibration modification combined with the torsional vibration damping arrangement 10 with power splitting is possible with different embodiments of coupling arrangements 51. The magnetic gear units shown in the preceding figures are only one possibility. FIG. 20 shows a torsional vibration damping arrangement 10 with power splitting. The coupling arrangement 51, also known as a superposition gear unit, is constructed in this instance as a planetary gear set 45 which, in this case, comprises a ring gear 53 which is connected to the external rotor 21 and which connects the first torque transmission path 47 to the coupling arrangement 51, a sun gear 54 which connects the second torque transmission path 48 to the coupling arrangement 51, and a planet gear 62 which is rotatably supported on a planet gear carrier 59. The planet gear carrier 59 forms the output of the coupling gear unit 51 and guides the output torque Mₐᵤₛ to the output region 55 and onward to a transmission 65, for example. This construction of a planetary gear set in connection with a torsional vibration damping arrangement 10 with power splitting is known from prior applications. It is also possible to use another known connection variant for the planetary gear set 45, for example, a variant with an input ring gear and an output ring gear which are connected to one another via a stepped planet gear. However, the critical feature consists in that an active vibration modification takes place in one of the two torque transmission paths 47; 48, particularly on the secondary element 2 of the phase shifter arrangement 44 and upstream of the coupling arrangement 51. In this case, the vibration modification is produced by an electric motor 105 which acts on the external rotor 21 and, depending on need, adds or subtracts torsional vibration energy.

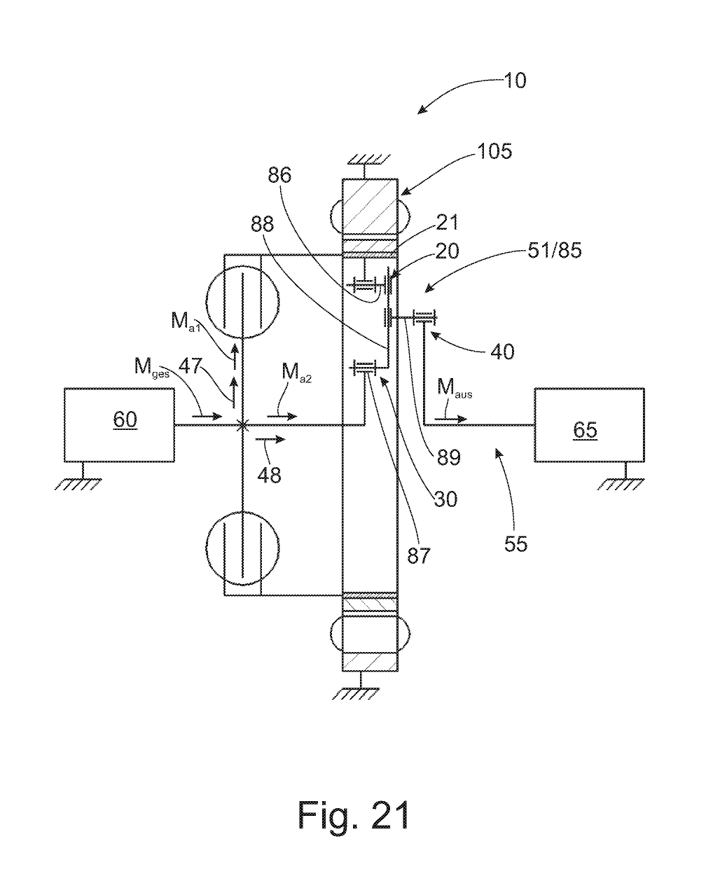

FIG. 21 shows a torsional vibration damping arrangement 10 with power splitting as was already described referring to FIG. 20. In this case, however, the coupling arrangement 51 is configured as a lever coupling gear unit 85. This constructional variant is also meant only as an example. Here also, further constructional variants and connection variants are known from the prior art. In the embodiment shown here, the external rotor 21 is implemented in the first torque transmission path 47 via a rotational sliding joint 86 as first input element 20 of the lever coupling gear unit 85. In the second torque transmission path 48, the second input element 30 is formed by a rotational joint 87. The two joints are connected by a coupling lever 87. The output element 40 of the lever coupling gear unit 85 is formed by a rotational sliding joint 89 which is connected to the output region 55 and which routes the output torque Mₐᵤₛ to a transmission 65, for example. The torsional vibration modification is also carried out in this case in the first torque transmission path 47 by the electric motor 105 as has already been described. It is also possible, but not shown here, that a torsional vibration modification is carried out in the second torque transmission path 48 with a further electric motor.

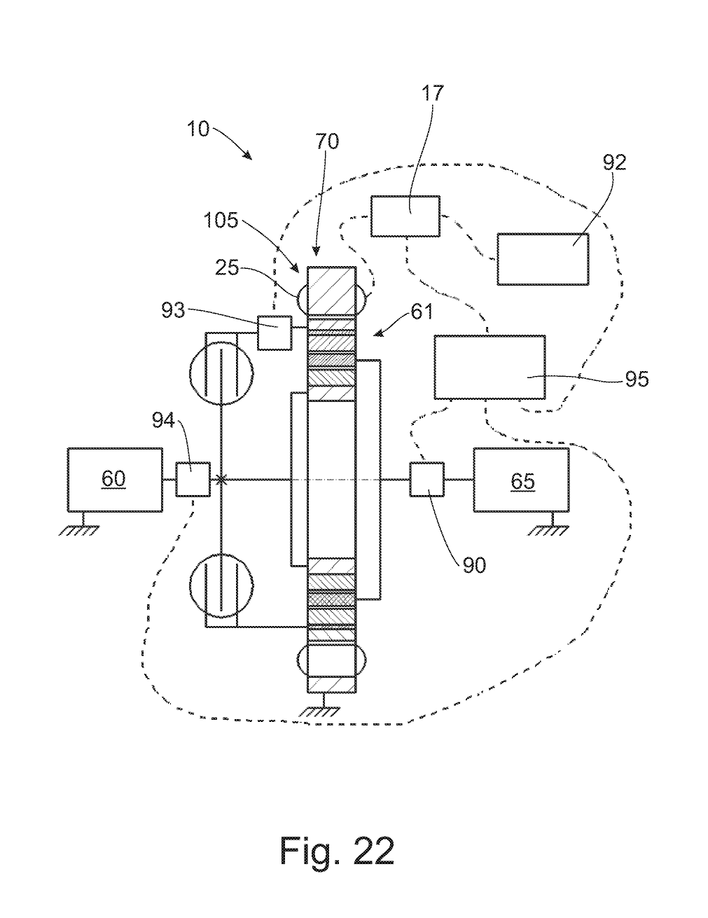

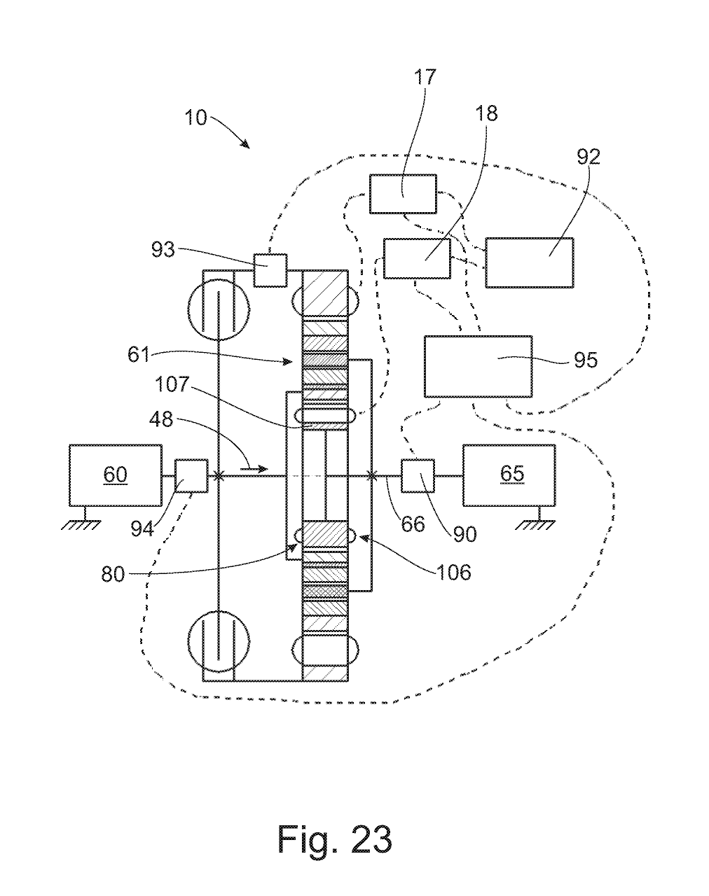

FIG. 22 shows a torsional vibration damping arrangement 10 with a magnetic coupling gear unit 61 and a torsional vibration modification arrangement 70 in the form of an electric motor 105 based on the basic principle already described referring to FIG. 17 and further components such as a sensor 90, an energy storage 92, a further sensor 93, a further sensor 94, a control device 95 and power electronics 17 for active control of the torsional vibration modification. Various arrangements and options for the arrangement of the mechanical components of a torsional vibration modification arrangement in a torsional vibration damping arrangement with power splitting have been described in the preceding descriptions of the figures.

However, further electronic components are also required for supplying and for controlling the torsional vibration modification arrangement 70 for the function of an active vibration reduction.

FIG. 22 shows, by way of example, the required components 90; 92, 93; 94; 95; 17 based on the torsional vibration modification with the electric motor 105. This applies analogously for other operating principles, already mentioned, for active vibration reduction or combination with other superposition gear units or connection combinations.

In order to achieve the vibration reduction by the active vibration modification in an advantageous manner, the stator winding 25 of the electric machine 105 is connected to power electronics 17 in FIG. 22. These power electronics 17 convert a DC current from an energy storage 92 to a required form, for example, a determined amperage, a determined frequency, a determined phase per winding, in electric motor operation. Conversely, this can also be carried out in generator operation of the electric machine 105 for an intermediate storage of the electrical energy. The control device 95 is provided for regulating the control of the electric machine 105. Additional vibration sensors can supply information besides the information which customarily already exists in the vehicle, for example, sensors for speed and torque and accelerator position. These sensors can be arranged in a useful manner at positions 90, 93 and 94 and supply information to the control device 95.

FIG. 23 shows a torsional vibration damping arrangement 10 such as that already described referring to FIG. 22, but with a further torsional vibration modification arrangement 80 with a second electric motor 106 in the second torque transmission path 48. Further power electronics 18 are required for this purpose in order to advantageously control the electric motor. The stator 107 is supported in this case at a transmission input shaft 66 via which a required power supply can also be carried out for the electric motor 106. However, although it is not shown here, a support in direction of the vehicle is also possible. The further manner of functioning follows from the description referring to FIGS. 19 and 22.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-12. (canceled)

13. A torsional vibration damping arrangement for a powertrain of a motor vehicle, comprising:
an input region to be driven for rotation around a rotational axis (A);
an output region, and parallel to one another between the input region and the output region a first torque transmission path for transmitting a first torque component (Mₐ₁) of a total torque (M_{ges}) to be transmitted between the input region and the output region and a second torque transmission path for transmitting a second torque component (Mₐ₂) of a total torque (M_{ges}) to be transmitted between the input region and the output region,
a phase shifter arrangement at least in the first torque transmission path for generating a phase shift of rotational irregularities conducted via the first torque transmission path in relation to rotational irregularities conducted via the second torque transmission path, wherein the phase shifter arrangement comprises a vibration system with a primary element and a secondary element which is rotatable relative to the primary element around the rotational axis (A) against the restoring action of a damper element arrangement,
a coupling arrangement for combining the first torque component (Mₐ₁) which is transmitted via the first torque transmission path and the second torque component (Mₐ₂) which is transmitted via the second torque transmission path and for routing the combined torque (Mₐᵤₛ) to the output region, wherein the coupling arrangement comprises a first input element connected to the first torque transmission path, a second input element connected to the second torque transmission path, and an output element connected to the output region, and
a torsional vibration modification arrangement arranged in the first torque transmission path between the phase shifter arrangement and the coupling arrangement and/or a torsional vibration modification arrangement arranged in the second torque transmission path upstream of the coupling arrangement.

14. The torsional vibration damping arrangement according to claim 13, wherein the torsional vibration modification arrangement; 80) comprises an energy storage.

15. The torsional vibration damping arrangement according to claim 13, wherein the torsional vibration modification arrangement; 80) is configured as an amplitude modification arrangement; 81) and/or as a phase shifter modification arrangement; 82).

16. The torsional vibration damping arrangement according to claim 13, wherein the torsional vibration modification arrangement; 80) comprises at least one sensor, a control device and an actuator; 100).

17. The torsional vibration damping arrangement according to claim 16, wherein the actuator, 100) is operated hydraulically and/or pneumatically.

18. The torsional vibration damping arrangement according to claim 16, wherein the actuator, 100) is operated electromechanically and/or electromagnetically.

19. The torsional vibration damping arrangement according to claim 16, wherein the energy storage is filled at least partially with energy from a torsional vibration in the first torque transmission path and/or in the second torque transmission path via the actuator; 100).

20. The torsional vibration damping arrangement according to claim 13, wherein the coupling arrangement is configured as a planetary gear set.

21. The torsional vibration damping arrangement according to claim 13, wherein the coupling arrangement is formed as a lever coupling gear unit.

22. The torsional vibration damping arrangement according to claim 13, wherein the coupling arrangement is constructed as a magnetic coupling gear unit.

23. The torsional vibration damping arrangement according to claim 13, wherein the coupling arrangement is constructed as an electromagnetic coupling gear unit.

24. The torsional vibration damping arrangement according to claim 13, wherein the torsional vibration modification arrangement; 80) is integrated in the coupling arrangement.
